(19) United States
(12) Patent Application Publication
(10) Pub. No.: US 2025/0096515 A1
(43) Pub. Date: Mar. 20, 2025

(54) CHAMBER FOR GAS LASER DEVICE, GAS LASER DEVICE, AND ELECTRONIC DEVICE MANUFACTURING METHOD

(71) Applicant: Gigaphoton Inc., Tochigi (JP)

(72) Inventors: Kazuki NAGAI, Oyama-shi (JP); Yoichi SASAKI, Oyama-shi (JP); Jeffrey P. SERCEL, Manchester, NH (US); Michael von DADELSZEN, Manchester, NH (US)

(73) Assignee: Gigaphoton Inc., Tochigi (JP)

(21) Appl. No.: 18/968,755

(22) Filed: Dec. 4, 2024

Related U.S. Application Data
(63) Continuation of application No. PCT/JP2023/020512, filed on Jun. 1, 2023.
(60) Provisional application No. 63/367,691, filed on Jul. 5, 2022.

(51) Int. Cl. H01S 3/038; H01S 3/034; H01S 3/225

(52) U.S. Cl. CPC H01S 3/0384; H01S 3/034; H01S 3/2251

(57) ABSTRACT

A chamber for a gas laser device includes first and second main electrodes arranged with a longitudinal direction being along a predetermined direction as being spaced apart from and facing each other in the internal space, a window arranged at a wall surface of the chamber, and a first preionization electrode arranged beside one side of the first main electrode. The first preionization electrode includes a first dielectric pipe extending along the longitudinal direction, a first preionization inner electrode arranged in the first dielectric pipe and extending along the longitudinal direction, and a first preionization outer electrode extending along the longitudinal direction, including a first end portion facing an outer circumference surface of the first dielectric pipe, and extending from the first end portion in a direction away from the first dielectric pipe. In a plane perpendicular to the longitudinal direction, a first corona discharge angle is an acute angle.

### CROSS-REFERENCE TO RELATED APPLICATIONS

The present application claims the benefit of International Application No. PCT/JP2023/020512, filed on Jun. 1, 2023, the entire contents of which are hereby incorporated by reference.

### BACKGROUND

### 1. Technical Field

The present disclosure relates to a chamber for a gas laser device, a gas laser device, and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 pm to 400 pm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be narrowed to the extent that the chromatic aberration can be ignored. For this purpose, there is a case in which a line narrowing module (LNM) including a line narrowing element (etalon, grating, and the like) is provided in a laser resonator of the gas laser device to narrow a spectral line width. In the following, a gas laser device with a narrowed spectral line width is referred to as a line narrowing gas laser device.

### LIST OF DOCUMENTS

### Patent Documents

Patent Document 1: Japanese Patent Application Publication No. 2001-177169
Patent Document 2: Japanese Patent Application Publication No. H5-327070

### SUMMARY

A chamber for a gas laser device according to an aspect of the present disclosure includes a first main electrode and a second main electrode arranged with a longitudinal direction thereof being along a predetermined direction as being spaced apart from and facing each other in the internal space, a window arranged at a wall surface of the chamber and configured to transmit light from the internal space, and a first preionization electrode arranged beside one side of the first main electrode. Here, the first preionization electrode includes a first dielectric pipe extending along the longitudinal direction, a first preionization inner electrode arranged in the first dielectric pipe and extending along the longitudinal direction, and a first preionization outer electrode extending along the longitudinal direction, including a first end portion facing an outer circumference surface of the first dielectric pipe, and extending from the first end portion in a direction away from the first dielectric pipe. In a plane perpendicular to the longitudinal direction, a first corona discharge angle, facing a space between the first main electrode and the second main electrode among angles formed by a first tangent in contact with the first dielectric pipe at a first predetermined position of the first dielectric pipe closest to the first end portion and a straight line that passes through the first predetermined position and extends in a direction in which the first preionization outer electrode extends from the first end portion, is an acute angle.

A gas laser device according to an aspect of the present disclosure includes a chamber that encloses a laser gas at an internal space thereof. Here, the chamber includes a first main electrode and a second main electrode arranged with a longitudinal direction thereof being along a predetermined direction as being spaced apart from and facing each other in the internal space, a window arranged at a wall surface of the chamber and configured to transmit light from the internal space, and a first preionization electrode arranged beside one side of the first main electrode. The first preionization electrode includes a first dielectric pipe extending along the longitudinal direction, a first preionization inner electrode arranged in the first dielectric pipe and extending along the longitudinal direction, and a first preionization outer electrode extending along the longitudinal direction, including a first end portion facing an outer circumference surface of the first dielectric pipe, and extending from the first end portion in a direction away from the first dielectric pipe. In a plane perpendicular to the longitudinal direction, a first corona discharge angle, facing a space between the first main electrode and the second main electrode among angles formed by a first tangent in contact with the first dielectric pipe at a first predetermined position of the first dielectric pipe closest to the first end portion and a straight line that passes through the first predetermined position and extends in a direction in which the first preionization outer electrode extends from the first end portion, is an acute angle.

An electronic device manufacturing method according to an aspect of the present disclosure includes generating laser light using a gas laser device, outputting the laser light to an exposure apparatus, and exposing a photosensitive substrate to the laser light in the exposure apparatus to manufacture an electronic device. Here, the gas laser device includes a chamber for the gas laser device having an internal space in which a laser gas is enclosed. The chamber includes a first main electrode and a second main electrode arranged with a longitudinal direction thereof being along a predetermined direction as being spaced apart from and facing each other in the internal space, a window arranged at a wall surface of the chamber and configured to transmit light from the internal space, and a first preionization electrode arranged beside one side of the first main electrode. The first preionization electrode includes a first dielectric pipe extending along the longitudinal direction, a first preionization inner electrode arranged in the first dielectric pipe and extending along the longitudinal direction, and a first preionization outer electrode extending along the longitudinal direction, including a first end portion facing an outer circumference surface of the first dielectric pipe, and extending from the first end portion in a direction away from the first dielectric pipe. In a plane perpendicular to the longitudinal direction, a first corona discharge angle, facing a space between the first main electrode and the second main electrode among angles formed by a first tangent in contact with the first dielectric pipe at a first predetermined position of the first dielectric pipe closest to the first end portion and a straight line that passes through the first predetermined position and extends in a direction in which the first preionization outer electrode extends from the first end portion, is an acute angle.

### BRIEF DESCRIPTION OF THE DRAWINGS

Embodiments of the present disclosure will be described below merely as examples with reference to the accompanying drawings.

FIG. 1 is a schematic view showing a schematic configuration example of an entire electronic device manufacturing apparatus.

FIG. 2 is a schematic view showing a schematic configuration example of an entire gas laser device of a comparative example.

FIG. 3 is a sectional view, perpendicular to a travel direction of laser light, of a chamber of the comparative example.

FIG. 4 is an electrical circuit diagram of the chamber of the comparative example.

FIG. 5 is a view showing the vicinity of a preionization electrode of a first embodiment along a Z direction.

FIG. 6 is an enlarged view of the vicinity of a first end portion shown in FIG. 5.

FIG. 7 is a diagram showing a simulation result of the relationship between a first corona discharge angle and a light emission area of ultraviolet light.

FIG. 8 is a diagram showing a simulation result of the relationship between an angle α and the first corona discharge angle in the first embodiment.

FIG. 9 is a diagram showing the relationship between the angle α and the first corona discharge angle and the relationship between the angle α and preionization intensity in a preferable range shown in FIG. 8.

FIG. 10 is a diagram showing the relationship between the angle α and the first corona discharge angle and the relationship between the angle α and the preionization intensity in a case in which the first corona discharge angle is 90° in FIG. 8.

FIG. 11 is a view showing the vicinity of the preionization electrode of a modification of the first embodiment along the Z direction.

FIG. 12 is an electrical circuit diagram of the chamber of a modification of the first embodiment.

FIG. 13 is a view showing the vicinity of the preionization electrode of a second embodiment along the Z direction.

FIG. 14 is an enlarged view of the vicinity of a first end portion shown in FIG. 13.

FIG. 15 is a diagram showing a simulation result of the relationship between the angle α and the first corona discharge angle in the second embodiment.

FIG. 16 is a diagram showing the relationship between the angle α and the first corona discharge angle and the relationship between the angle α and the preionization intensity in a preferable range shown in FIG. 15.

FIG. 17 is a diagram showing the relationship between the angle α and the first corona discharge angle and the relationship between the angle α and the preionization intensity in a case in which the first corona discharge angle is 90° in FIG. 15.

FIG. 18 is a view showing the vicinity of the preionization electrode of a third embodiment along the Z direction.

FIG. 19 is an electrical circuit diagram of the chamber of the third embodiment.

FIG. 20 is a view showing the vicinity of the preionization electrode of a fourth embodiment along the Z direction.

FIG. 21 is an electrical circuit diagram of the chamber of the fourth embodiment.

### DESCRIPTION OF EMBODIMENTS

1. Description of electronic device manufacturing apparatus used in exposure process for electronic device
2. Description of gas laser device of comparative example
   2.1 Configuration
   2.2 Operation
   2.3 Problem
3. Description of chamber of first embodiment
   3.1 Configuration
   3.2 Effect
4. Description of chamber of second embodiment
   4.1 Configuration
   4.2 Effect
5. Description of chamber of third embodiment
   5.1 Configuration
   5.2 Effect
6. Description of chamber of fourth embodiment
   6.1 Configuration
   6.2 Effect

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted. In the drawings referred to below, the dimensions of each member may be changed for ease of understanding.

### 1. Description of Electronic Device Manufacturing Apparatus Used in Exposure Process for Electronic Device

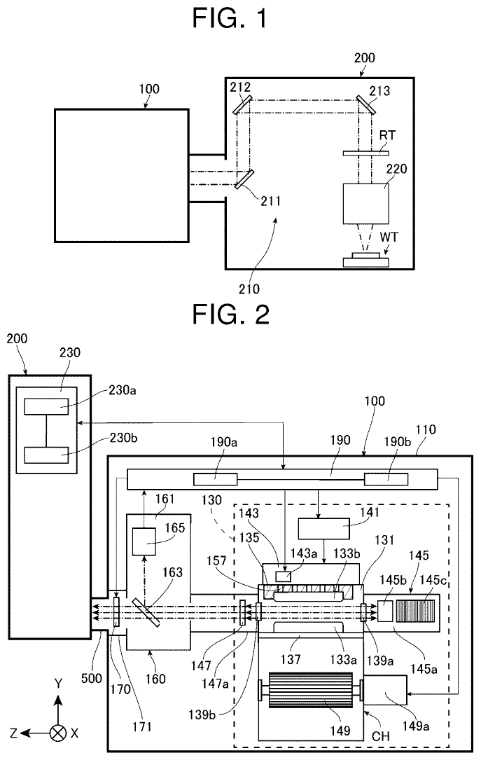

FIG. 1 is a schematic view showing a schematic configuration example of an entire electronic device manufacturing apparatus used in an exposure process for an electronic device. As shown in FIG. 1, the manufacturing apparatus used in the exposure process includes a gas laser device 100 and an exposure apparatus 200. The exposure apparatus 200 includes an illumination optical system 210 including a plurality of mirrors 211, 212, 213 and a projection optical system 220. The illumination optical system 210 illuminates a reticle pattern of a reticle stage RT with laser light incident from the gas laser device 100. The projection optical system 220 causes the laser light transmitted through the reticle to be imaged as being reduced and projected on a workpiece (not shown) arranged on a workpiece table WT. The workpiece is a photosensitive substrate such as a semiconductor wafer on which photoresist is applied. The exposure apparatus 200 synchronously translates the reticle stage RT and the workpiece table WT to expose the workpiece to the laser light reflecting the reticle pattern. Through the exposure process as described above, a device pattern is transferred onto the semiconductor wafer, thereby a semiconductor device, which is the electronic device, can be manufactured.

### 2. Description of Gas Laser Device of Comparative Example

### 2.1 Configuration

The gas laser device 100 of a comparative example will be described. The comparative example of the present disclosure is an example recognized by the applicant as known only by the applicant, and is not a publicly known example admitted by the applicant.

FIG. 2 is a schematic view showing a schematic configuration example of the entire gas laser device 100 of the comparative example. The gas laser device 100 is, for example, an ArF excimer laser device using a mixed gas including argon (Ar), fluorine (F₂), and neon (Ne). The gas laser device 100 outputs laser light having a center wavelength of about 193 nm. Here, the gas laser device 100 may be a gas laser device other than the ArF excimer laser device, and may be, for example, a KrF excimer laser device using a mixed gas including krypton (Kr), F₂, and Ne. In this case, the gas laser device 100 outputs laser light having a center wavelength of about 248 nm. The mixed gas containing Ar, F₂, and Ne which is a laser medium and the mixed gas containing Kr, F₂, and Ne which is a laser medium may be each referred to as a laser gas.

The gas laser device 100 includes a housing 110, and a laser oscillator 130, a monitor module 160, a shutter 170, and a laser processor 190 arranged at the internal space of the housing 110 as a main configuration.

The laser oscillator 130 includes a chamber device CH, a charger 141, a pulse power module 143, a line narrowing module 145, and an output coupling mirror 147. In FIG. 2, the internal configuration of the chamber device CH is shown as viewed from a direction substantially perpendicular to the travel direction of the laser light.

Examples of the material of a chamber 131 of the chamber device CH include a metal such as nickel-plated aluminum and nickel-plated stainless steel. The chamber 131 includes an internal space in which light is generated by excitation of a laser medium in the laser gas. The light travels toward windows 139a, 139b described later. The laser gas is supplied from a laser gas supply source (not shown) to the internal space of the chamber 131 through a pipe (not shown). Further, the laser gas in the chamber 131 is subjected to a process of removing an F₂ gas by a halogen filter or the like, and is exhausted to the outside of the housing 110 through a pipe (not shown) by an exhaust pump (not shown).

At the internal space of the chamber 131, an electrode 133a which is a first main electrode and an electrode 133b which is a second main electrode are spaced apart from and face each other, and each longitudinal direction is along the travel direction of the laser light. In the following, the longitudinal direction of the electrodes 133a, 133b may be referred to as a Z direction, the direction which is perpendicular to the Z direction and in which the electrodes 133a, 133b are juxtaposed and the electrodes 133a, 133b are spaced apart from each other may be referred to as a Y direction, and the direction perpendicular to the Y direction and the Z direction may be referred to as an X direction. The electrodes 133a, 133b are discharge electrodes for exciting the laser medium by glow discharge. In the present example, the electrode 133a is the anode and the electrode 133b is the cathode.

The electrode 133a is supported by and electrically connected to an electrode holder portion 137. The electrode 133b is fixed to a surface of a plate-shaped electrical insulating portion 135 on a side facing the internal space of the chamber 131 by a conductive member 157 which is, for example, a bolt. The conductive member 157 is electrically connected to the pulse power module 143, and applies a high voltage from the pulse power module 143 to the electrode 133b.

The electrical insulating portion 135 includes an insulator. Examples of the material of the electrical insulating portion 135 include alumina ceramics having low reactivity with an F₂ gas. The electrical insulating portion 135 may have electrical insulation, and the material of the electrical insulating portion 135 may be a resin such as a phenol resin and a fluoro-resin, or quartz, glass, or the like. The electrical insulating portion 135 blocks an opening provided in the chamber 131 and is fixed to the chamber 131.

The charger 141 is a DC power source device that charges a charging capacitor (not shown) in the pulse power module 143 with a predetermined voltage. The pulse power module 143 includes a switch 143a controlled by the laser processor 190. When the switch 143a is turned ON from OFF, the pulse power module 143 generates a pulse high voltage from the electric energy charged in the charging capacitor and applies the high voltage between the electrode 133a and the electrode 133b.

When the high voltage is applied between the electrode 133a and the electrode 133b, discharge occurs between the electrode 133a and the electrode 133b. The laser medium in the chamber 131 is excited by the energy of the discharge, and the excited laser medium emits light when shifting to the ground state.

A pair of windows 139a, 139b are arranged on a wall surface of the chamber 131. The window 139a is located at one end side of the chamber 131 in the travel direction of the laser light, the window 139b is located at the other end side in the travel direction, and the windows 139a, 139b sandwich a space between the electrode 133a and the electrode 133b. The windows 139a, 139b are inclined at the Brewster angle with respect to the travel direction of the laser light so that P-polarized light of the laser light is suppressed from being reflected. The laser light oscillated as described later is output to the outside of the chamber 131 through the windows 139a, 139b.

The line narrowing module 145 includes a housing 145a, and a prism 145b, a grating 145c, and a rotation stage (not shown) arranged at the internal space of the housing 145a. An opening is formed in the housing 145a, and the housing 145a is connected to the rear side of the chamber 131 through the opening.

The prism 145b expands the beam width of the light output from the window 139a and causes the light to be incident on the grating 145c. Further, the prism 145b also reduces the beam width of the reflection light from the grating 145c and returns the light to the internal space of the chamber 131 through the window 139a. The prism 145b is supported by the rotation stage and is rotated by the rotation stage. The incident angle of the light with respect to the grating 145c is changed by the rotation of the prism 145b. Therefore, by rotating the prism 145b, the wavelength of the light returning from the grating 145c to the chamber 131 via the prism 145b can be selected. Although FIG. 2 shows an example in which one prism 145b is arranged, at least one prism may be arranged.

The surface of the grating 145c is configured of a material having a high reflectance, and a large number of grooves are formed on the surface at predetermined intervals. The cross sectional shape of each groove is, for example, a right-angled triangle. The light incident on the grating 145c from the prism 145b is diffracted in a direction corresponding to the wavelength of the light when reflected by the grooves. The grating 145c is arranged in the Littrow arrangement, which causes the incident angle of the light incident on the grating 145c from the prism 145b to coincide with the diffraction angle of the diffracted light having a desired wavelength. Thus, light having a wavelength close to the desired wavelength returns into the chamber 131 via the prism 145b.

The output coupling mirror 147 is arranged at the internal space of an optical path pipe 147a connected to the front side of the chamber 131, and faces the window 139b. The output coupling mirror 147 transmits a part of the laser light output from the window 139b toward the monitor module 160, and reflects another part of the laser light to return to the internal space of the chamber 131 through the window 139b. Thus, the grating 145c and the output coupling mirror 147 configure a Fabry-Perot laser resonator, and the chamber 131 is arranged on the optical path of the laser resonator.

The monitor module 160 is arranged on the optical path of the laser light output from the output coupling mirror 147. The monitor module 160 includes a housing 161, and a beam splitter 163 and an optical sensor 165 arranged at the internal space of the housing 161. An opening is formed in the housing 161, and the internal space of the housing 161 communicates with the internal space of the optical path pipe 147a through the opening.

The beam splitter 163 transmits a part of the laser light output from the output coupling mirror 147 toward the shutter 170, and reflects another part of the laser light toward a light receiving surface of the optical sensor 165. The optical sensor 165 measures an energy E of the laser light incident on the light receiving surface, and outputs a signal indicating the measured energy E to the laser processor 190.

The laser processor 190 of the present disclosure is a processing device including a storage device 190a in which a control program is stored and a central processing unit (CPU) 190b that executes the control program. The laser processor 190 is specially configured or programmed to perform various processes included in the present disclosure. Further, the laser processor 190 controls the entire gas laser device 100.

The laser processor 190 transmits and receives various signals to and from an exposure processor 230 of the exposure apparatus 200. For example, the laser processor 190 receives a signal indicating a later-described light emission trigger Tr and a later-described target energy Et from the exposure processor 230. The target energy Et is a target value of the energy of the laser light to be used in the exposure process. The laser processor 190 controls the charge voltage of the charger 141 based on the energy E and the target energy Et received from the optical sensor 165 and the exposure processor 230, respectively. By controlling the charge voltage, the energy of the laser light is controlled. Further, the laser processor 190 transmits a command signal of ON or OFF of the switch 143a to the pulse power module 143.

The laser processor 190 is electrically connected to the shutter 170 and controls opening and closing of the shutter 170. The laser processor 190 closes the shutter 170 until a difference ΔE between the energy E received from the monitor module 160 and the target energy Et received from the exposure processor 230 falls within an allowable range. When the difference ΔE falls within the allowable range, the laser processor 190 transmits, to the exposure processor 230, a reception preparation completion signal indicating that reception preparation of the light emission trigger Tr is completed. The exposure processor 230 transmits a signal indicating the light emission trigger Tr to the laser processor 190 when receiving the reception preparation completion signal, and the laser processor 190 opens the shutter 170 when receiving the signal indicating the light emission trigger Tr. The light emission trigger Tr is defined by a predetermined repetition frequency f and a predetermined number of pulses P of the laser light, is a timing signal for the exposure processor 230 to cause the laser oscillator 130 to perform laser oscillation, and is an external trigger. The repetition frequency f of the laser light is, for example, equal to or more than 100 Hz and equal to or less than 10 kHz.

The shutter 170 is arranged on the optical path of the laser light at the internal space of an optical path pipe 171 communicating with an opening formed at the housing 161 of the monitor module 160 on a side opposite to the side to which the optical path pipe 147a is connected. The internal spaces of the optical path pipes 171, 147a and the internal spaces of the housings 161, 145a are supplied and filled with a purge gas. The purge gas includes an inert gas such as nitrogen (N₂). The purge gas is supplied from a purge gas supply source (not shown) through a pipe (not shown). The optical path pipe 171 is in communication with the exposure apparatus 200 through the opening of the housing 110 and the optical path pipe 500 connecting the housing 110 and the exposure apparatus 200. The laser light having passed through the shutter 170 enters the exposure apparatus 200.

The exposure processor 230 of the present disclosure is a processing device including a storage device 230a in which a control program is stored and a CPU 230b that executes the control program. The exposure processor 230 is specifically configured or programmed to perform various processes included in the present disclosure. Further, the exposure processor 230 controls the entire exposure apparatus 200.

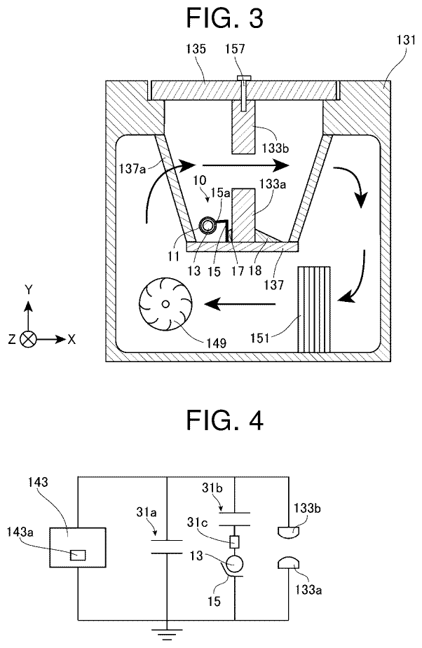

FIG. 3 is a sectional view, perpendicular to the travel direction of the laser light, of the chamber 131 of the comparative example. A cross flow fan 149 and a heat exchanger 151 are further arranged at the internal space of the chamber 131.

The cross flow fan 149 and the heat exchanger 151 are arranged on a side opposite to the electrode 133a with respect to the electrode holder portion 137. At the internal space of the chamber 131, the space in which the cross flow fan 149 and the heat exchanger 151 are arranged is in communication with the space between the electrode 133a and the electrode 133b. The heat exchanger 151 is a radiator arranged beside the cross flow fan 149 and connected to a pipe (not shown) through which a cooling medium, which is a liquid or a gas, flows. As shown in FIG. 2, the cross flow fan 149 is connected to a motor 149a arranged outside the chamber 131, and rotates with rotation of the motor 149a. As the cross flow fan 149 rotates, the laser gas enclosed at the internal space of the chamber 131 circulates as indicated by bold arrows in FIG. 3. That is, the laser gas circulates through the cross flow fan 149, a space between the electrode 133a and the electrode 133b, the heat exchanger 151, and the cross flow fan 149 in this order. At least a part of the circulating laser gas passes through the heat exchanger 151, and the temperature of the laser gas is adjusted by the heat exchanger 151. Due to circulation of the laser gas, impurities of the laser gas generated by main discharge between the electrode 133a and the electrode 133b move downstream, and a fresh laser gas is supplied between the electrode 133a and the electrode 133b for subsequent discharge. Further, when the laser gas passes through the heat exchanger 151, heat caused by main discharge is removed, and an increase in temperature of the laser gas is suppressed. ON/OFF and the number of revolution of the motor 149a are controlled by the laser processor 190. Accordingly, the laser processor 190 can adjust the circulation speed of the laser gas circulating through the internal space of the chamber 131 by controlling the motor 149a.

The electrode holder portion 137 is electrically connected to the chamber 131 via wirings 137a. The electrode 133a supported by the electrode holder portion 137 is connected to the ground potential via the electrode holder portion 137, the wirings 137a, and the chamber 131.

A preionization electrode 10 is provided on the electrode holder portion 137 beside the electrode 133a. The preionization electrode 10 is arranged upstream of the laser gas flowing between the electrode 133a and the electrode 133b in the X direction. The preionization electrode 10 includes a dielectric pipe 11, a preionization inner electrode, and a preionization outer electrode. Hereinafter, each of the preionization inner electrode and the preionization outer electrode may be referred to as an inner electrode 13 and an outer electrode 15.

The dielectric pipe 11 has, for example, a cylindrical shape, and is arranged with the longitudinal direction thereof oriented along the Z direction. Examples of the material of the dielectric pipe 11 include alumina ceramics and sapphire.

The inner electrode 13 has a rod shape, is arranged inside the dielectric pipe 11, and extends along the Z direction. Examples of the material of the inner electrode 13 include copper and brass.

The outer electrode 15 is provided between the dielectric pipe 11 and the electrode 133a, and extends along the Z direction. The outer electrode 15 includes an end portion 15a that faces a part of the outer circumference surface of the dielectric pipe 11. The end portion 15a is arranged from one end to the other end of the outer electrode 15 in the Z direction. The outer electrode 15 extends from the end portion 15a in a direction away from the dielectric pipe 11. Further, the outer electrode 15 is bent in an XY plane that is a plane perpendicular to the Z direction, and due to the bending, the end portion 15a is in contact with the outer circumference surface of the dielectric pipe 11 so as to push the outer circumference surface of the dielectric pipe 11. The end portion 15a is in contact with the outer circumference surface of the dielectric pipe 11 over the entire length in the Z direction. A screw hole (not shown) is provided at an end portion of the outer electrode 15 on a side opposite to the end portion 15a, and the outer electrode 15 is fixed to a guide 17 by a screw (not shown) screwed into the screw hole. The guide 17 is fixed to the electrode 133a. Therefore, it can be understood that the outer electrode 15 is fixed to the electrode 133a via the guide 17. Here, the outer electrode 15 is only required to be fixed between the dielectric pipe 11 and the electrode 133a, and may be directly fixed to the electrode 133a. Examples of the material of the outer electrode 15 include copper and brass. The outer electrode 15 may be manufactured by bending a plate-shaped member.

On the electrode holder portion 137, a guide 18 is further arranged beside the electrode 133a on a side opposite to the guide 17. Thus, the electrode 133a is sandwiched between the guides 17, 18. The guides 17, 18 guide the laser gas so that the laser gas from the cross flow fan 149 flows between the electrode 133a and the electrode 133b. Examples of the material of the guides 17, 18 include a porous nickel metal having low reactivity with an F₂ gas.

A pair of holders 28 (not shown) are fixed on the electrode holder portion 137 beside the electrode 133a. One end of the dielectric pipe 11 is inserted to a hole (not shown) of one holder, and the other end of the dielectric pipe 11 is inserted to a hole (not shown) of the other holder. Thus, the dielectric pipe 11 is held by the holders.

FIG. 4 is an electrical circuit diagram of the chamber 131 of the comparative example. Further, a peaking capacitor 31a and a preionization capacitor 31b are arranged at the chamber 131. The inner electrode 13 is electrically connected to one end of the preionization capacitor 31b via a current introduction terminal 31c. The outer electrode 15 is electrically connected to the electrode 133a via the electrode holder portion 137, and is electrically connected to the chamber 131 via the electrode holder portion 137 and the wirings 137a. The outer electrode 15, the electrode holder portion 137, the wirings 137a, and the chamber 131 are at the ground potential. The pulse power module 143 is electrically connected to the peaking capacitor 31a and the preionization capacitor 31b so that, when the switch 143a of the pulse power module 143 is turned ON, charges stored in the charging capacitor (not shown) of the pulse power module 143 are transferred to the peaking capacitor 31a and the preionization capacitor 31b. Further, a voltage is applied between the outer electrode 15 and the inner electrode 13 so that the potential of the outer electrode 15 becomes higher than the potential of the inner electrode 13.

### 2.2 Operation

Next, operation of the gas laser device 100 of the comparative example will be described.

Before the gas laser device 100 outputs the laser light, the internal spaces of the optical path pipes 147a, 171, 500 and the internal spaces of the housings 145a, 161 are filled with a purge gas from the purge gas supply source (not shown). Further, a laser gas is supplied to the internal space of the chamber 131 from the laser gas supply source (not shown). When the laser gas is supplied, the laser processor 190 controls the motor 149a to rotate the cross flow fan 149. By the rotation of the cross flow fan 149, the laser gas circulates through the internal space of the chamber 131.

Before the gas laser device 100 outputs the laser light, the laser processor 190 receives a signal indicating the target energy Et and the signal indicating the light emission trigger Tr from the exposure processor 230. Further, the laser processor 190 turns ON the switch 143a of the pulse power module 143. Thus, the pulse power module 143 applies a pulse high voltage, from the electric energy charged in the charging capacitor (not shown), between the electrode 133a and the electrode 133b and between the inner electrode 13 and the outer electrode 15. When the high voltage is applied between the inner electrode 13 and the outer electrode 15, corona discharge occurs in the vicinity of the dielectric pipe 11 and the end portion 15a, and ultraviolet light is emitted. When the laser gas between the electrode 133a and the electrode 133b is irradiated with the ultraviolet light, the laser gas between the electrode 133a and the electrode 133b undergoes preionization. After preionization, when the voltage between the electrode 133a and the electrode 133b reaches a breakdown voltage, main discharge between the electrode 133a and the electrode 133b occurs. Then, excimer is generated from the laser medium contained in the laser gas between the electrode 133a and the electrode 133b, and light is emitted when the excimer is dissociated. The light resonates between the grating 145c and the output coupling mirror 147, and is amplified every time it passes through the discharge space at the internal space of the chamber 131, thereby causing laser oscillation. Then, a part of the laser light is transmitted through the output coupling mirror 147 as pulse laser light and travels toward the beam splitter 163.

A part of the laser light traveling to the beam splitter 163 is reflected by the beam splitter 163 and received by the optical sensor 165. The optical sensor 165 measures the energy E of the received laser light, and outputs a signal indicating the energy E to the laser processor 190. The laser processor 190 performs control on the charge voltage so that the difference DE between the energy E and the target energy Et is within the allowable range.

### 2.3 Problem

In the gas laser device 100 of the comparative example, when preionization intensity due to the preionization electrode 10 between the electrode 133a and the electrode 133b is low, unstable main discharge occurs. As a result, the stability of the energy of the laser light output from the gas laser device 100 may decrease. Accordingly, there arises a concern that the laser light satisfying the performance required by the exposure apparatus 200 is not output. Therefore, there is a demand to increase the preionization intensity.

Therefore, in each of the following embodiments, the chamber 131 of the gas laser device 100 capable of increasing the preionization intensity is exemplified.

### 3. Description of Chamber of First Embodiment

Next, the chamber 131 of the present embodiment will be described. Any component same as that described above is denoted by an identical reference sign, and duplicate description thereof is omitted unless specific description is needed. Further, in some drawings, some members may be omitted or simplified for easy viewing.

### 3.1 Configuration

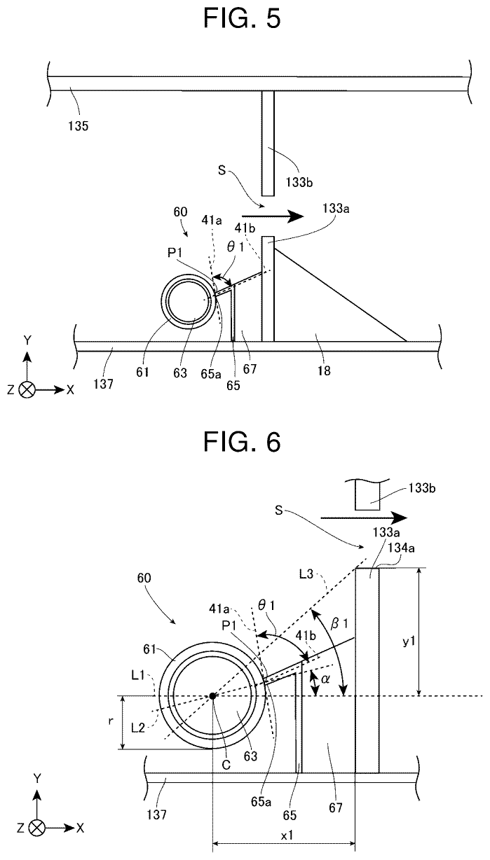

FIG. 5 is a view showing the vicinity of the preionization electrode of the present embodiment along the Z direction. In FIG. 5, the flow of the laser gas is indicated by a bold arrow.

In the following, for convenience of explanation, the preionization electrode will be described as a first preionization electrode. Here, the first preionization electrode may be referred to as a preionization electrode 60. The preionization electrode 60 is similar to the preionization electrode 10 of the comparative example.

For convenience of explanation, the members of the preionization electrode 60 will be described as a first dielectric pipe, a first preionization inner electrode, a first preionization outer electrode, and a first end portion of the first preionization outer electrode, and may be referred to as a dielectric pipe 61, an inner electrode 63, an outer electrode 65, and a first end portion 65a, respectively. Further, the guide 17 may be referred to as a first guide 67 by changing the reference numeral to 67.

The preionization electrode 60 of the present embodiment differs from the comparative example in which a first corona discharge angle θ1 is an obtuse angle in that the first corona discharge angle θ1 is an acute angle at the first end portion 65a.

The first corona discharge angle θ1 is an angle facing a space S between the electrode 133a and the electrode 133b among the angles formed by a first tangent 41a and a straight line 41b in the plane perpendicular to the Z direction. That is, the first corona discharge angle θ1 is an angle at which the laser gas between the electrode 133a and the electrode 133b is preionized. The first tangent 41a is a straight line in contact with the dielectric pipe 61 at a first predetermined position P1 of the dielectric pipe 61 closest to the first end portion 65a. The straight line 41b is a line passing through the first predetermined position P1 and extends in the direction in which the outer electrode 65 extends from the first end portion 65a. In the present embodiment, since the first end portion 65a is in contact with a part of the outer circumference surface of the dielectric pipe 61, the first predetermined position P1 is also a contact position at which the first end portion 65a is in contact with the part.

FIG. 6 is an enlarged view of the vicinity of the first end portion 65a shown in FIG. 5. In FIG. 6, the guide 18 is not shown. In FIG. 6, the radius of the dielectric pipe 61 is shown as r, and a straight line perpendicular to a spaced direction in which the electrode 133a and the electrode 133b are spaced apart from each other in the plane perpendicular to the Z direction and passing through a center C of the dielectric pipe 61 is shown as a first straight line L1. Further, a distance from the first straight line L1 to a first facing surface 134a of the electrode 133a facing the electrode 133b in the spaced direction is shown as y1. Further, in the X direction, a distance from the center C of the dielectric pipe 61 to a side surface of the electrode 133a facing the dielectric pipe 61 is shown as x1. The dielectric pipe 61 of the present embodiment is arranged such that the following expressions (1) and (2) are satisfied.

$$y l \geq r \qquad ( 1 )$$

$$xl > r \qquad ( 2 )$$

In FIG. 6, in the plane perpendicular to the Z direction, an angle formed by the first straight line L1 and a second straight line L2 passing through the first predetermined position P1 of the dielectric pipe 61 closest to the first end portion 65a and the center C of the dielectric pipe 61 is shown as a. Further, in the present embodiment, in the plane perpendicular to the Z direction, an angle formed by the first straight line L1 and a third straight line L3 passing through the center C of the dielectric pipe 61 and an edge of the first facing surface 134a on the dielectric pipe 61 side is shown as β1. The angles α, β1 are acute angles. In the chamber 131 of the present embodiment, the following expressions (3) and (4) are satisfied.

$$0 \leq α < β1 \qquad ( 3 )$$

$$90 ° + α - {tan}^{- 1} ( y 1 - r sin α ) / x 1 - r cos α ) ) ) \leq θ1 < 90 ° \qquad ( 4 )$$

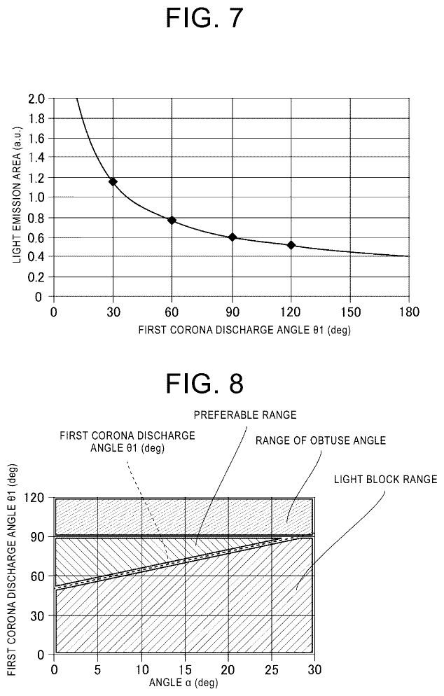

FIG. 7 is a diagram showing a simulation result of the relationship between the first corona discharge angle θ1 and a light emission area of the ultraviolet light. The light emission area is a light emission area in the vicinity of the dielectric pipe 61 and the first end portion 65a. The simulation result is obtained by calculating the electric field strength in the vicinity of the dielectric pipe 61 and the first end portion 65a. In the simulation, the potential of the inner electrode 63 is −3 kV, the potential of the outer electrode 65 is 0 V, and the area of the region at which the electric field strength is 3 kV/mm or higher corresponds to the light emission area of the ultraviolet light. The above values of the potential of the inner electrode 63 and the potential of the outer electrode 65 are typical values with which corona discharge occurs in the vicinity of the dielectric pipe 61 and the first end portion 65a. The potential of the inner electrode 63 and the potential of the outer electrode 65 for obtaining the simulation result shown in FIG. 7 are not particularly limited as long as corona discharge occurs. The gas pressure in the chamber 131 of the present embodiment is equal to or higher than 220 kPa and equal to or lower than 280 kPa, and the potential of the outer electrode 65 at the beginning of corona discharge in this case is −3 kV. Here, the potential of the outer electrode 65 at the beginning of corona discharge when the gas pressure is equal to or higher than 200 kPa and equal to or lower than 420 kPa is also considered to be −3 kV. At such a gas pressure, a region at which the electric field strength is 3 kV/mm or higher is considered to be a region at which corona discharge occurs first. The intensity of the ultraviolet light generated from this region is high, and the larger the area of the region is, that is, the light emission area is, the larger the light amount of the ultraviolet light is and the higher the preionization intensity is.

In FIG. 7, the horizontal axis represents the magnitude of the first corona discharge angle θ1, and the vertical axis represents the light emission area. The light emission area is indicated as a relative value. When the first corona discharge angles θ1 are 30°, 60°, 90°, and 120°, the light emission areas are 1.18, 0.79, 0.60, and 0.52, respectively. For example, in the comparative example, the light emission area is 0.49 when the first corona discharge angle θ1 is 131°, and in the present embodiment, the light emission area is 0.74 when the first corona discharge angle θ1 is 65°. Thus, the light emission area of the present embodiment is about 1.5 times the light emission area of the comparative example. From the simulation result shown in FIG. 7, it can be seen that, when the first corona discharge angle θ1 decreases, the light emission area increases and the preionization intensity increases.

FIG. 8 is a diagram showing a simulation result of the relationship between the angle α and the first corona discharge angle θ1 in the present embodiment. In FIG. 8, the distance x1 is 19.0 mm, the distance y1 is 9.7 mm, and the radius r is 7.0 mm. In FIG. 8, a range between a broken line indicating the first corona discharge angle θ1 and a line indicating the first corona discharge angle θ1 being 90° is a range in which the preionization intensity becomes a preferable intensity for the present embodiment as the first end portion 65a does not block the ultraviolet light generated from the vicinity of the dielectric pipe 61 and the first end portion 65a, and the ultraviolet light travels to the space S between the electrode 133a and the electrode 133b. Hereinafter, the range may be simply referred to as a preferable range. Further, a range below the broken line indicating the first corona discharge angle θ1 is a range in which the first end portion 65a is located closer to the electrode 133b than the third line L3 and blocks a part of the ultraviolet light. When the angle α is equal to or less than 0°, the dielectric pipe 61 blocks a part of the ultraviolet light. In FIG. 8, for easy viewing, the preferable range, a range of an obtuse angle, and a light block range are shown as being separated from the broken line indicating the first corona discharge angle θ1, lines indicating the first corona discharge angle θ1 being 0°, 90°, and 120°, and lines indicating the angle α being 0° and 30°. The above values of the distance x1, the distance y1, and the radius r are typical values with which the preionization becomes preferable intensity. Here, values of the distance x1, the distance y1, and the radius r for obtaining the simulation result shown in FIG. 8 are not particularly limited.

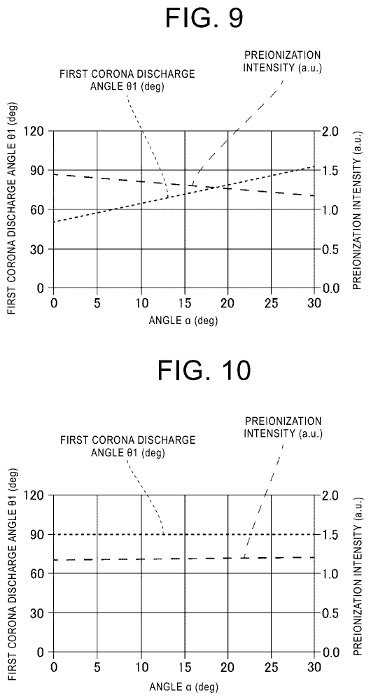

FIG. 9 is a diagram showing the relationship between the angle α and the first corona discharge angle θ1 and the relationship between the angle α and the preionization intensity in the preferable range shown in FIG. 8. It can be seen from FIG. 9 that the first corona discharge angle θ1 decreases as the angle α decreases. Further, it can be seen that, when the first corona discharge angle θ1 decreases, the preionization intensity increases since the light emission area increases as shown in FIG. 6. Accordingly, in the present embodiment, the smaller the angle α is, the higher the preionization intensity is. In the present embodiment, the angle α is 280 or less. When the angle α is 0°, the first corona discharge angle θ1 is 55°.

FIG. 10 is a diagram showing the relationship between the angle α and the first corona discharge angle θ1 and the relationship between the angle α and the preionization intensity in a case in which the first corona discharge angle θ1 is 900 in FIG. 8. It can be seen that, when the first corona discharge angle θ1 is 90°, the preionization intensity is substantially constant regardless of the magnitude of the angle α, and the influence of the angle α on the preionization intensity is small.

### 3.2 Effect

When the high voltage is applied between the inner electrode 63 and the outer electrode 65, corona discharge occurs in the vicinity of the dielectric pipe 61 and the first end portion 65a, and ultraviolet light is emitted. When the laser gas between the electrode 133a and the electrode 133b is irradiated with the ultraviolet light, the laser gas between the electrode 133a and the electrode 133b undergoes preionization. After preionization, when the voltage between the electrode 133a and the electrode 133b reaches a breakdown voltage, main discharge between the electrode 133a and the electrode 133b occurs. In the chamber 131 of the present embodiment, the first corona discharge angle θ1 is an acute angle. According to this configuration, the light emission area of the ultraviolet light between the dielectric pipe 61 and the first end portion 65a can be increased and the light amount of the ultraviolet light can be increased, as compared with a case in which the first corona discharge angle θ1 is an obtuse angle. As a result, the preionization intensity can be increased, and a decrease in the stability of the laser light output from the gas laser device 100 can be suppressed. Therefore, the laser light satisfying the performance required by the exposure apparatus 200 can be output.

Here, the preionization electrode 60 of the present embodiment may be arranged downstream of the laser gas flowing between the electrode 133a and the electrode 133b in the X direction, with respect to the electrode 133a. In the present embodiment, the first main electrode is the electrode 133a, the second main electrode is the electrode 133b, and the preionization electrode 60 is arranged beside the electrode 133a, which is the first main electrode. However, the first main electrode may be the electrode 133b, the second main electrode may be the electrode 133a, and the preionization electrode 60 may be arranged beside the electrode 133b, which is the first main electrode. Further, when the first corona discharge angle θ1 is an acute angle, the expressions (1), (2), (3), and (4) may not be satisfied.

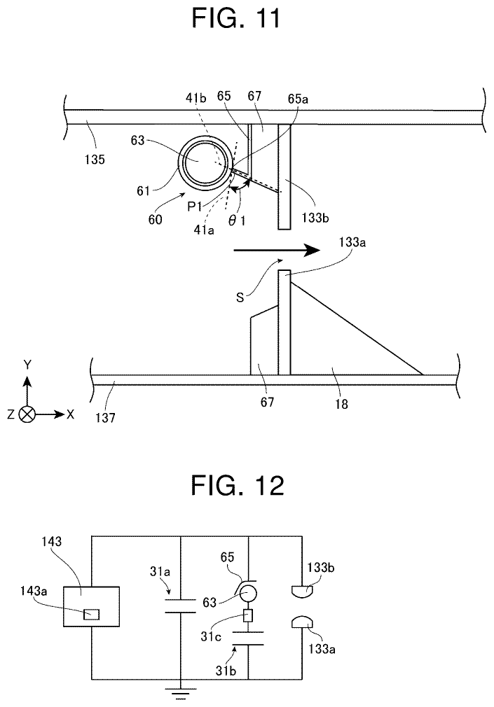

FIG. 11 is a view showing the vicinity of the preionization electrode 60 in a modification of the present embodiment along the Z direction. In the preionization electrode 60 of the present modification, the arrangement position of the preionization electrode 60 is different from that of the first embodiment. The preionization electrode 60 of the present modification is provided beside the electrode 133b, which is the second main electrode, on one side thereof in the X direction. The first corona discharge angle θ1 of the present modification is an acute angle as in the first embodiment. The preionization electrode 60 of the present modification is also arranged upstream of the laser gas flowing between the electrode 133a and the electrode 133b in the X direction. In FIG. 11, the flow of the laser gas is indicated by a bold arrow.

The first guide 67 of the present modification is fixed to the electrode 133b on a surface of the electrical insulating portion 135 on a side facing the internal space of the chamber 131. Therefore, the outer electrode 65 is fixed to the electrode 133b via the first guide 67. Here, the outer electrode 65 may be directly fixed to the electrode 133b.

FIG. 12 is an electrical circuit diagram of the chamber 131 of a modification of the present embodiment. The outer electrode 65 is electrically connected to the electrode 133b and the pulse power module 143. The inner electrode 63 is electrically connected to one end of the preionization capacitor 31b via the current introduction terminal 31c. The preionization capacitor 31b is connected to the ground potential.

In the present modification as well, a voltage is applied between the outer electrode 65 and the inner electrode 63 so that the potential of the outer electrode 65 becomes lower than the potential of the inner electrode 63. Accordingly, fluorine ions move toward the inner electrode 63, that is, toward the dielectric pipe 61. Therefore, corrosion of the outer electrode 65 due to fluorine ions can be suppressed.

Here, the preionization electrode 60 of the present modification may be arranged downstream of the laser gas flowing between the electrode 133b and the electrode 133a in the X direction.

### 4. Description of Chamber of Second Embodiment

Next, the chamber 131 of a second embodiment will be described. Any component same as that described above is denoted by an identical reference sign, and duplicate description thereof is omitted unless specific description is needed. Further, in some drawings, some members may be omitted or simplified for easy viewing.

### 4.1 Configuration

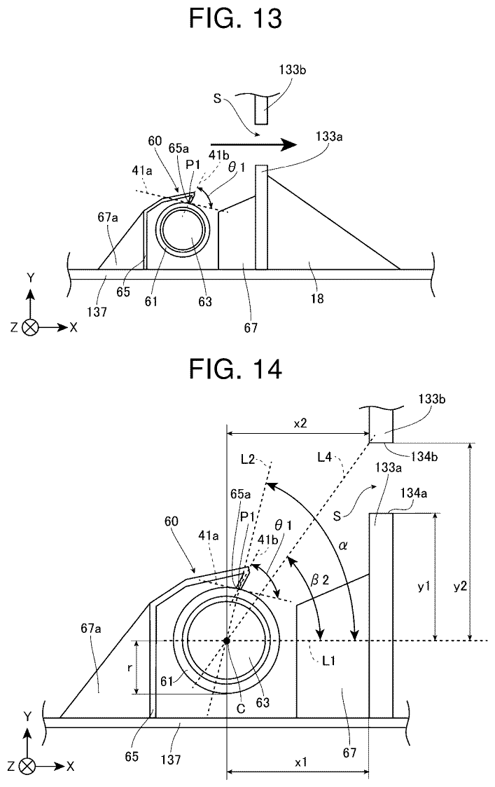

FIG. 13 is a view showing the vicinity of the preionization electrode 60 of the present embodiment along the Z direction. In FIG. 13, the flow of the laser gas is indicated by a bold arrow.

In the outer electrode 65 of the present embodiment, the arrangement position of the outer electrode 65 is different from that of the first embodiment. The outer electrode 65 of the present embodiment differs from the first embodiment in that the outer electrode 65 is fixed on a side opposite to the electrode 133a with respect to the dielectric pipe 61. The outer electrode 65 is fixed to a guide 67a provided upstream of the outer electrode 65 by a screw (not shown) screwed into a screw hole of the outer electrode 65. The guide 67a is a conductor fixed to the electrode holder portion 137. The guide 67a guides the laser gas so that the laser gas from the cross flow fan 149 flows between the electrode 133a and the electrode 133b. The material of the guide 67a may be the same material as the first guide 67. Here, the guide 67a may not be provided.

FIG. 14 is an enlarged view of the vicinity of the first end portion 65a shown in FIG. 13. The first corona discharge angle θ1 of the present embodiment is an acute angle as in the first embodiment. In FIG. 14, the guide 18 is not shown.

In FIG. 14, a facing surface of the electrode 133b facing the electrode 133a is shown as a second facing surface 134b. Further, in FIG. 14, a distance from the first straight line L1 to the second facing surface 134b in the spaced direction is shown as y2. Further, the distance from the center C of the dielectric pipe 61 to an upstream side surface of the electrode 133b in a direction perpendicular to the Z direction and the spaced direction is shown as x2. The dielectric pipe 61 of the present embodiment is arranged such that the following expressions (5) and (6) are satisfied.

$$y 2 \geq r \qquad ( 5 )$$

$$x 2 > r \qquad ( 6 )$$

In the present embodiment as well, the angle formed by the first straight line L1 and the second straight line L2 is shown as a in FIG. 14. Further, in the plane perpendicular to the Z direction, an angle formed by the first straight line L1 and a fourth straight line L4 passing through the center C of the dielectric pipe 61 and an edge of the second facing surface 134b on the dielectric pipe 61 side is shown as β2. The angle β2 is an acute angle. In the chamber 131 of the present embodiment, the following expressions (7) and (8) are satisfied.

$$β 2 < α < 90 ° \qquad ( 7 )$$

$$90 ° - α + {tan}^{- 1} ( y 2 - r sin α ) / x 2 - r cos α ) ) ) \leq θ1 < 90 ° \qquad ( 8 )$$

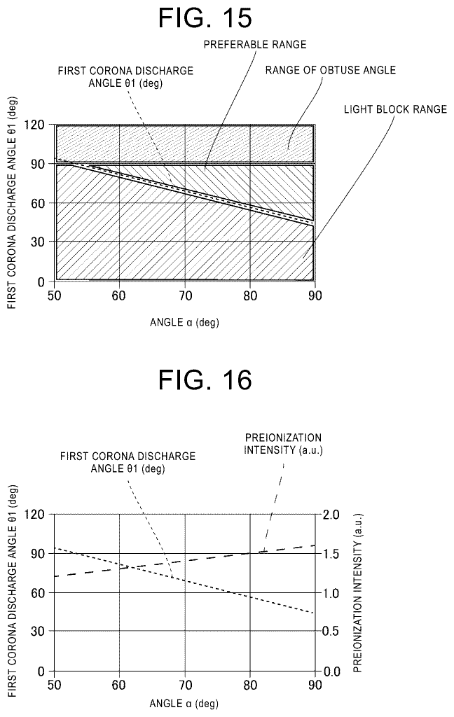

FIG. 15 is a diagram showing a simulation result of the relationship between the angle α and the first corona discharge angle θ1 in the present embodiment. In FIG. 15, the distance x2 is 19.0 mm, the distance y2 is 25.7 mm, and the radius r is 7.0 mm. In FIG. 15, a range between a broken line indicating the first corona discharge angle θ1 and a line indicating the first corona discharge angle θ1 being 900 is a range in which the preionization intensity becomes a preferable intensity for the present embodiment as the first end portion 65a does not block the ultraviolet light generated from the vicinity of the dielectric pipe 61 and the first end portion 65a, and the ultraviolet light travels to the space S between the electrode 133a and the electrode 133b. Hereinafter, the range may be simply referred to as a preferable range. Further, a range below the broken line indicating the first corona discharge angle θ1 is a range in which the first end portion 65a is located closer to the electrode 133a than the fourth line L4 and blocks a part of the ultraviolet light. When the angle α is equal to or more than 90°, the dielectric pipe 61 blocks a part of the ultraviolet light. In FIG. 15, for easy viewing, the preferable range, a range of an obtuse angle, and a light block range are shown as being separated from the broken line indicating the first corona discharge angle θ1, lines indicating the first corona discharge angle θ1 being 0°, 90°, and 120°, and lines indicating the angle α being 50° and 90°. The above values of the distance x2, the distance y2, and the radius r are typical values creating a range in which the preionization becomes preferable intensity. Here, values of the distance x2, the distance y2, and the radius r for obtaining the simulation result shown in FIG. 15 are not particularly limited.

FIG. 16 is a diagram showing the relationship between the angle α and the first corona discharge angle θ1 and the relationship between the angle α and the preionization intensity in the preferable range shown in FIG. 15. It can be seen from FIG. 16 that the first corona discharge angle θ1 decreases as the angle α increases. It can be seen that, when the first corona discharge angle θ1 decreases, the preionization intensity increases since the light emission area increases as shown in FIG. 7. Accordingly, in the present embodiment, the smaller the angle α is, the higher the preionization intensity is. In the present embodiment, the angle α is equal to or more than 53° and equal to or less than 90°.

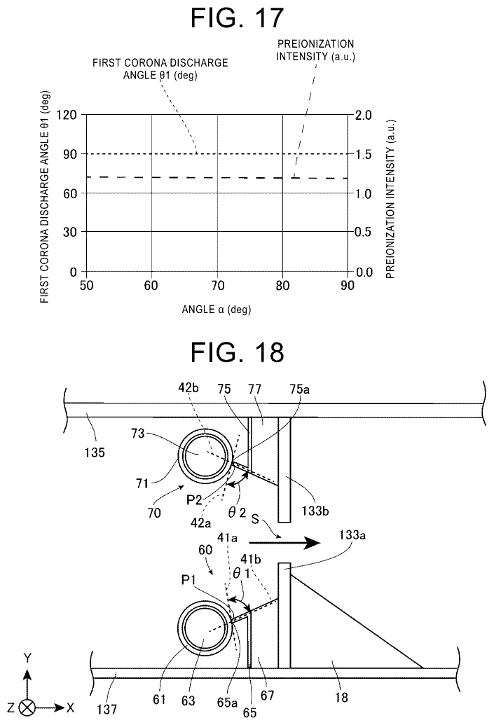

FIG. 17 is a diagram showing the relationship between the angle α and the first corona discharge angle θ1 and the relationship between the angle α and the preionization intensity in a case in which the first corona discharge angle θ1 is 900 in FIG. 15. It can be seen that, when the first corona discharge angle θ1 is 90°, the preionization intensity is substantially constant regardless of the magnitude of the angle α, and the influence of the angle α on the preionization intensity is small.

### 4.2 Effect

Even though the outer electrode 65 is provided on a side opposite to the electrode 133a with respect to the dielectric pipe 61 unlike the first embodiment, the first corona discharge angle θ1 of the present embodiment is an acute angle. According to this configuration, the light emission area of the ultraviolet light between the dielectric pipe 61 and the first end portion 65a can be increased and the light amount of the ultraviolet light can be increased, as compared with a case in which the first corona discharge angle θ1 is an obtuse angle. As a result, the preionization intensity can be increased, and a decrease in the stability of the laser light output from the gas laser device 100 can be suppressed. Therefore, the laser light satisfying the performance required by the exposure apparatus 200 can be output.

Here, the preionization electrode 60 of the present embodiment may be arranged downstream of the laser gas flowing between the electrode 133a and the electrode 133b in the X direction, with respect to the electrode 133a. Further, when the first corona discharge angle θ1 is an acute angle, the expressions (5), (6), (7), and (8) may not be satisfied.

### 5. Description of Chamber of Third Embodiment

Next, the chamber 131 of a third embodiment will be described. Any component same as that described above is denoted by an identical reference sign, and duplicate description thereof is omitted unless specific description is needed. Further, in some drawings, some members may be omitted or simplified for easy viewing.

### 5.1 Configuration

FIG. 18 is a view showing the vicinity of the preionization electrode of the present embodiment along the Z direction. The chamber 131 of the present embodiment differs from that of the first embodiment in that another preionization electrode is added to the first embodiment. In the following, for convenience of explanation, the added preionization electrode will be described as a second preionization electrode. The second preionization electrode may be referred to as a preionization electrode 70. The preionization electrode 70 has the same configuration as the preionization electrode 60 in the modification of the first embodiment, and is simply changed in sign.

For convenience of explanation, the members of the preionization electrode 70 will be described as a second dielectric pipe, a second preionization inner electrode, a second preionization outer electrode, and a second end portion, and may be referred to as a dielectric pipe 71, an inner electrode 73, an outer electrode 75, and a second end portion 75a, respectively.

The preionization electrode 70 is provided at a position facing the preionization electrode 60 beside the electrode 133b. The preionization electrodes 60, 70 are arranged upstream of the laser gas flowing between the electrode 133a and the electrode 133b in the X direction. In FIG. 18, the flow of the laser gas is indicated by a bold arrow.

Further, the tangent, the straight line, and the corona discharge angle of the preionization electrode 70 may be referred to as a second tangent 42a, a straight line 42b, and a second corona discharge angle θ2, respectively. The second tangent 42a, the straight line 42b, and the second corona discharge angle θ2 correspond to the first tangent 41a, the straight line 41b, and the first corona discharge angle θ1 in the modification of the first embodiment, respectively, and are simply changed in name and sign. Since the preionization electrode 70 has the same configuration as the preionization electrode 60, the second corona discharge angle θ2 of the present embodiment is an acute angle similar to the first corona discharge angle θ1. Further, the second corona discharge angle θ2 is an angle facing the space S between the electrode 133a and the electrode 133b among the angles formed by the second tangent 42a and the straight line 42b in the plane perpendicular to the Z direction. That is, the second corona discharge angle θ2 is an angle at which the laser gas between the electrode 133a and the electrode 133b is preionized. The second tangent 42a is a straight line in contact with the dielectric pipe 71 at a second predetermined position P2 of the dielectric pipe 71 closest to the second end portion 75a. The straight line 42b is a line passing through the second predetermined position P2 and extends in the direction in which the outer electrode 75 extends from the second end portion 75a. In the present embodiment as well, expressions (1), (2), (3), and (4) are satisfied.

A second guide 77 having the same configuration as the first guide 67 of the modification of the first embodiment is arranged on a surface of the electrical insulating portion 135 of the present embodiment on a side facing the internal space of the chamber 131. Therefore, the outer electrode 75 is fixed to the electrode 133b via the second guide 77. Here, the outer electrode 75 may be directly fixed to the electrode 133b.

A pair of holders (not shown) having the same configuration as the holder on the dielectric pipe 61 side are provided on the surface of the electrical insulating portion 135 of the present embodiment on the side facing the internal space of the chamber 131. Similarly to the holding of the dielectric pipe 61 by the pair of holders on the dielectric pipe 61 side, one end side of the dielectric pipe 71 is inserted to a hole of one holder (not shown) and held thereby, and the other end side of the dielectric pipe 71 is inserted to a hole (not shown) of the other holder (not shown) and held thereby. One end of the inner electrode 63 and one end of the inner electrode 73 are electrically connected to each other by an inner electrode connector (not shown).

The other end of the inner electrode 63 and the other end of the inner electrode 73 may also be electrically connected to each other by an inner electrode connector. The inner electrode connector has a cylindrical shape, but may have a wire shape. The other end of the outer electrode 75 is electrically connected to the electrode 133b.

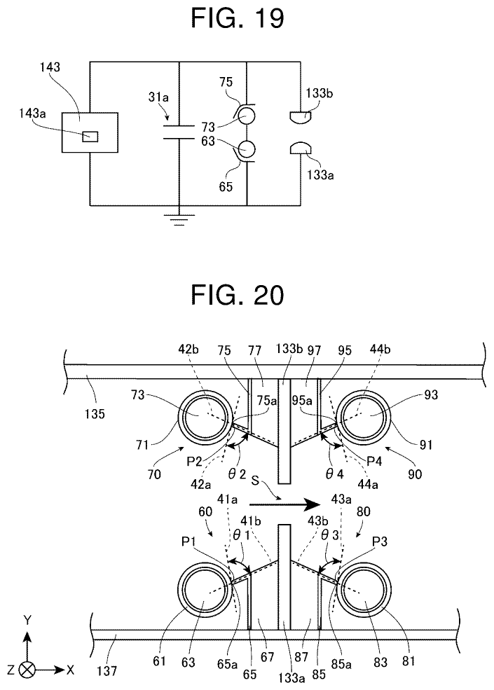

FIG. 19 is an electrical circuit diagram of the chamber 131 according to the present embodiment. The electrical circuit diagram of the present embodiment differs from the electrical circuit diagram of the comparative example in that the preionization capacitor 31b and the current introduction terminal 31c are not arranged. When the switch 143a is turned ON, charges stored in the charging capacitor are transferred to the peaking capacitor 31a, and at the same time, the voltage between the electrode 133a and the electrode 133b increases. Further, a half of the voltage between the electrode 133a and the electrode 133b is induced in each of the inner electrodes 63, 73. Accordingly, corona discharge occurs in the vicinity of the dielectric pipe 61 and the first end portion 65a and in the vicinity of the dielectric pipe 71 and the second end portion 75a, and the ultraviolet light is emitted from each of them. When the laser gas between the electrode 133a and the electrode 133b is irradiated with the ultraviolet light, the laser gas between the electrode 133a and the electrode 133b undergoes preionization. After preionization, when the voltage between the electrode 133a and the electrode 133b reaches a breakdown voltage, main discharge between the electrode 133a and the electrode 133b occurs. Then, excimer is generated from the laser medium contained in the laser gas between the electrode 133a and the electrode 133b, and light is emitted when the excimer is dissociated.

### 5.2 Effect

According to this configuration, the light emission area of the ultraviolet light between the dielectric pipe 71 and the second end portion 75a can be increased and the light amount of the ultraviolet light can be increased, as compared with a case in which the second corona discharge angle θ2 is an obtuse angle. As a result, the preionization intensity can be increased, and a decrease in the stability of the laser light output from the gas laser device 100 can be suppressed. Therefore, the laser light satisfying the performance required by the exposure apparatus 200 can be output. Further, according to this configuration, the preionization intensity can be increased as compared with a case in which only one of the preionization electrodes 60, 70 is provided.

### 6. Description of Chamber of Fourth Embodiment

Next, the chamber 131 of a fourth embodiment will be described. Any component same as that described above is denoted by an identical reference sign, and duplicate description thereof is omitted unless specific description is needed. Further, in some drawings, some members may be omitted or simplified for easy viewing.

### 6.1 Configuration

FIG. 20 is a view showing the vicinity of the preionization electrodes 60, 70 of the present embodiment along the Z direction.

The chamber 131 of the present embodiment differs from that of the third embodiment in that two preionization electrodes are further added to the third embodiment. For convenience of explanation, the two added preionization electrodes will be described as a third preionization electrode and a fourth preionization electrode, and may be referred to as a preionization electrode 80 and a preionization electrode 90.

Each of the preionization electrodes 80, 90 has the same configuration as the preionization electrode 60, while the preionization electrode 80 is arranged beside the electrode 133a and the preionization electrode 90 is arranged beside the electrode 133b.

For convenience of explanation, the members of the preionization electrode 80 will be described as a third dielectric pipe, a third preionization inner electrode, a third preionization outer electrode, and a third end portion, and may be referred to as a dielectric pipe 81, an inner electrode 83, an outer electrode 85, and a third end portion 85a, respectively. Further, the members of the preionization electrode 90 will be described as a fourth dielectric pipe, a fourth preionization inner electrode, a fourth preionization outer electrode, and a fourth end portion, and may be referred to as a dielectric pipe 91, an inner electrode 93, an outer electrode 95, and a fourth end portion 95a, respectively.

The preionization electrode 80 is arranged beside the electrode 133a on the other side thereof in the X direction, that is, on a side opposite to the preionization electrode 60. Further, the preionization electrode 90 is arranged beside the electrode 133b on the other side thereof, that is, on a side opposite to the preionization electrode 70, and at a position facing the preionization electrode 80. The preionization electrode 80 and the preionization electrode 90 are arranged downstream of the laser gas flowing between the electrode 133a and the electrode 133b in the X direction. In FIG. 20, the flow of the laser gas is indicated by a bold arrow.

Further, the tangent, the straight line, and the corona discharge angle of the preionization electrode 80 may be referred to as a third tangent 43a, a straight line 43b, and a third corona discharge angle θ3, respectively, and the tangent, the straight line, and the corona discharge angle of the preionization electrode 90 may be referred to as a fourth tangent 44a, a straight line 44b, and a fourth corona discharge angle θ4, respectively. The preionization electrode 80 is configured as reversing the preionization electrode 60 with respect to the electrode 133a, and the preionization electrode 90 is configured as reversing the preionization electrode 70 with respect to the electrode 133b. Since the preionization electrodes 80, 90 have the same configuration as the preionization electrode 60, the third corona discharge angle θ3 and the fourth corona discharge angel θ4 of the present embodiment are acute angles similar to the first corona discharge angle θ1. Further, the third corona discharge angle θ3 is an angle facing the space S between the electrode 133a and the electrode 133b among the angles formed by the third tangent 43a and the straight line 43b in the plane perpendicular to the Z direction. The fourth corona discharge angle θ4 is an angle facing the space S between the electrode 133a and the electrode 133b among the angles formed by the fourth tangent 44a and the straight line 44b in the plane perpendicular to the Z direction. That is, each of the corona discharge angle θ3, θ4 is an angle at which the laser gas between the electrode 133a and the electrode 133b is preionized. The third tangent 43a is a straight line in contact with the dielectric pipe 81 at a third predetermined position P3 of the dielectric pipe 81 closest to the third end portion 85a. The straight line 43b is a line passing through the third predetermined position P3 and extends in the direction in which the outer electrode 85 extends from the third end portion 85a. The fourth tangent 44a is a straight line in contact with the dielectric pipe 91 at a fourth predetermined position P4 of the dielectric pipe 91 closest to the fourth end portion 95a. The straight line 44b is a line passing through the fourth predetermined position P4 and extends in the direction in which the outer electrode 95 extends from the fourth end portion 95a. In the present embodiment as well, expressions (1), (2), (3), and (4) are satisfied.

The electrode holder portion 137 of the present embodiment is provided with a third guide 87 having the same configuration as the first guide 67 and fixed to the electrode 133a. Further, a fourth guide 97 having the same configuration as the second guide 77 and fixed to the electrode 133b is provided on a surface of the electrical insulating portion 135 on a side facing the internal space of the chamber 131. The outer electrodes 85, 95 are individually fixed to the guides 87, 97 respectively in the same manner as the fixing of the outer electrodes 65, 75 to the guides 67, 77. Therefore, the outer electrode 85 is fixed to the electrode 133a via the third guide 87, and the outer electrode 95 is fixed to the electrode 133b via the fourth guide 97. Here, the outer electrode 85 may be directly fixed to the electrode 133a, and the outer electrode 95 may be directly fixed to the electrode 133b.

Each of the pair of holders holding the dielectric pipe 61 of the present embodiment extends in the X direction, and includes holes (not shown) at the upstream side and the downstream side of the flow of the laser gas. One end side of the dielectric pipe 61 is inserted to the hole of one holder on the upstream side, and one end side of the dielectric pipe 81 is inserted to the hole of the one holder on the downstream side. Thus, one end side of the dielectric pipe 61 and one end side of the dielectric pipe 81 are held by the one holder. Further, the other end side of the dielectric pipe 61 is inserted to the hole of the other holder on the upstream side, and the other end side of the dielectric pipe 81 is inserted to the hole of the other holder on the downstream side. Accordingly, the other end side of the dielectric pipe 61 and the other end side of the dielectric pipe 81 are held by the other holder.

Each of the pair of holders holding the dielectric pipe 71 of the present embodiment extends in the X direction, and includes holes (not shown) at the upstream side and the downstream side of the flow of the laser gas. One end side of the dielectric pipe 71 is inserted to the hole of one holder on the upstream side, and one end side of the dielectric pipe 91 is inserted to the hole of the one holder on the downstream side. Thus, one end side of the dielectric pipe 71 and one end side of the dielectric pipe 91 are held by the one holder. Further, the other end side of the dielectric pipe 71 is inserted to the hole of the other holder on the upstream side, and the other end side of the dielectric pipe 91 is inserted to the hole of the other holder on the downstream side. Accordingly, the other end side of the dielectric pipe 71 and the other end side of the dielectric pipe 91 are held by the other holder.

One end of the inner electrode 83 and one end of the inner electrode 93 are electrically connected to each other by an inner electrode connector having the same configuration as the inner electrode connector for the inner electrodes 63, 73. The other end of the inner electrode 83 and the other end of the inner electrode 93 may also be electrically connected to each other by an inner electrode connector. The other end of the outer electrode 85 is electrically connected to the electrode 133a via the electrode holder portion 137, and is electrically connected to the chamber 131 via the electrode holder portion 137 and the wirings 137a. The outer electrode 85, the electrode holder portion 137, the wirings 137a, and the chamber 131 are at the ground potential. The other end of the outer electrode 95 is electrically connected to the electrode 133b.

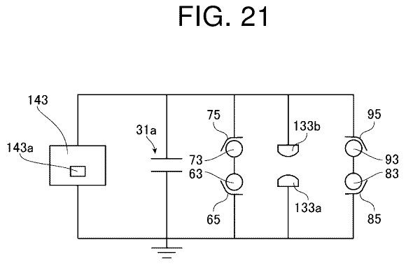

FIG. 21 is an electrical circuit diagram of the chamber 131 according to the present embodiment. When the switch 143a is turned ON, charges stored in the charging capacitor are transferred to the peaking capacitor 31a, and at the same time, the voltage between the electrode 133a and the electrode 133b increases. Further, a half of the voltage between the electrode 133a and the electrode 133b is induced in each of the inner electrodes 63, 73, 83, 93. Accordingly, corona discharge occurs in the vicinity of the dielectric pipe 61 and the first end portion 65a, in the vicinity of the dielectric pipe 71 and the second end portion 75a, in the vicinity of the dielectric pipe 81 and the third end portion 85a, and in the vicinity of the dielectric pipe 91 and the fourth end portion 95a, and the ultraviolet light is emitted from each of them. When the laser gas between the electrode 133a and the electrode 133b is irradiated with the ultraviolet light, the laser gas between the electrode 133a and the electrode 133b undergoes preionization. Then, main discharge occurs between the electrode 133a and the electrode 133b. Then, excimer is generated from the laser medium contained in the laser gas between the electrode 133a and the electrode 133b, and light is emitted when the excimer is dissociated.

### 6.2 Effect

According to this configuration, the light emission area of the ultraviolet light between the dielectric pipe 81 and the third end portion 85a and the light emission area of the ultraviolet light between the dielectric pipe 91 and the fourth end portion 95a can be increased and the light amount of the ultraviolet light can be increased, as compared with a case in which the corona discharge angles θ3, θ4 are obtuse angles. As a result, the preionization intensity can be increased, and a decrease in the stability of the laser light output from the gas laser device 100 can be suppressed. Therefore, the laser light satisfying the performance required by the exposure apparatus 200 can be output. Further, according to this configuration, the preionization intensity can be increased as compared with a case in which only one of the preionization electrodes 60, 70, 80, 90 is provided.

Here, in the chamber 131 of the present embodiment, any of the four preionization electrodes 60, 70, 80, 90 may not be arranged.

The description above is intended to be illustrative and the present disclosure is not limited thereto. Therefore, it would be obvious to those skilled in the art that various modifications to the embodiment of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of the any thereof and any other than A, B, and C.

What is claimed is:

1. A chamber for a gas laser device having an internal space in which a laser gas is enclosed, comprising;
a first main electrode and a second main electrode arranged with a longitudinal direction thereof being along a predetermined direction as being spaced apart from and facing each other in the internal space;
a window arranged at a wall surface of the chamber and configured to transmit light from the internal space; and
a first preionization electrode arranged beside one side of the first main electrode,
the first preionization electrode including a first dielectric pipe extending along the longitudinal direction, a first preionization inner electrode arranged in the first dielectric pipe and extending along the longitudinal direction, and a first preionization outer electrode extending along the longitudinal direction, including a first end portion facing an outer circumference surface of the first dielectric pipe, and extending from the first end portion in a direction away from the first dielectric pipe, and
in a plane perpendicular to the longitudinal direction, a first corona discharge angle, as facing a space between the first main electrode and the second main electrode among angles formed by a first tangent in contact with the first dielectric pipe at a first predetermined position of the first dielectric pipe closest to the first end portion and a straight line that passes through the first predetermined position and extends in a direction in which the first preionization outer electrode extends from the first end portion, being an acute angle.

2. The chamber for a gas laser device according to claim 1,
wherein an expression of y1≥r is satisfied,
where a radius of the first dielectric pipe is r, and
a distance, in the plane perpendicular to the longitudinal direction, from a first straight line being perpendicular to a spaced direction in which the first main electrode and the second main electrode are spaced apart from each other and passing through a center of the first dielectric pipe to a first facing surface of the first main electrode facing the second main electrode in the spaced direction is y1.

3. The chamber for a gas laser device according to claim 2,
wherein the first preionization outer electrode is arranged between the first main electrode and the first dielectric pipe, and
an expression of 0≤α<β1 is satisfied,
where an angle, in the plane perpendicular to the longitudinal direction, formed by the first straight line and a second straight line passing through the first predetermined position and the center of the first dielectric pipe is α, and
an angle, in the plane perpendicular to the longitudinal direction, formed by the first straight line and a third straight line passing through the center of the first dielectric pipe and an edge of the first facing surface on a side toward the first dielectric pipe is β1.

4. The chamber for a gas laser device according to claim 3,
wherein an expression of
90°+α−tan⁻¹((y1−r sin α)/x1−r cos α)))≤θ1<90° is satisfied,
where a distance, in a direction perpendicular to the longitudinal direction and the spaced direction, from the center of the first dielectric pipe to the first main electrode is x1, and
the first corona discharge angle is θ1.

5. The chamber for a gas laser device according to claim 2,
wherein the first preionization outer electrode is fixed to a side opposite to the first main electrode with respect to the first dielectric pipe,
the second main electrode includes a second facing surface facing the first main electrode, and
an expression of β2<α<90° is satisfied,
where an angle, in the plane perpendicular to the longitudinal direction, formed by the first straight line and a second straight line passing through the first predetermined position and the center of the first dielectric pipe is α, and
an angle, in the plane perpendicular to the longitudinal direction, formed by the first straight line and a fourth straight line passing through the center of the first dielectric pipe and an edge of the second facing surface on a side toward the first dielectric pipe is (2.

6. The chamber for a gas laser device according to claim 5,
wherein an expression of
90°−α+tan⁻¹((y2−r sin α)/x2−r cos α)))≤θ1<90° is satisfied,
where a distance, in the plane perpendicular to the longitudinal direction, from the first straight line to the second facing surface in the spaced direction is y2,
a distance, in a direction perpendicular to the longitudinal direction and the spaced direction, from the center of the first dielectric pipe to the second main electrode is x2, and
the first corona discharge angle is θ1.

7. The chamber for a gas laser device according to claim 1,
further comprising a second preionization electrode arranged beside the one side of the second main electrode at a position facing the first preionization electrode,
wherein the second preionization electrode includes a second dielectric pipe extending along the longitudinal direction, a second preionization inner electrode arranged in the second dielectric pipe and extending along the longitudinal direction, and a second preionization outer electrode extending along the longitudinal direction, including a second end portion facing an outer circumference surface of the second dielectric pipe, and extending from the second end portion in a direction away from the second dielectric pipe, and
in the plane perpendicular to the longitudinal direction, a second corona discharge angle, facing a space between the first main electrode and the second main electrode among angles formed by a second tangent in contact with the second dielectric pipe at a second predetermined position of the second dielectric pipe closest to the second end portion and a straight line that passes through the second predetermined position and extends in a direction in which the second preionization outer electrode extends from the second end portion, is an acute angle.

8. The chamber for a gas laser device according to claim 7,
wherein the first preionization inner electrode is electrically connected to the second preionization inner electrode,
the first preionization outer electrode is electrically connected to the first main electrode, and
the second preionization outer electrode is electrically connected to the second main electrode.

9. The chamber for a gas laser device according to claim 7, further comprising:
a third preionization electrode arranged beside the other side of the first main electrode; and
a fourth preionization electrode arranged beside the other side of the second main electrode at a position facing the third preionization electrode,
wherein the third preionization electrode includes a third dielectric pipe extending along the longitudinal direction, a third preionization inner electrode arranged in the third dielectric pipe and extending along the longitudinal direction, and a third preionization outer electrode extending along the longitudinal direction, including a third end portion facing an outer circumference surface of the third dielectric pipe, and extending from the third end portion in a direction away from the third dielectric pipe,
the fourth preionization electrode includes a fourth dielectric pipe extending along the longitudinal direction, a fourth preionization inner electrode arranged in the fourth dielectric pipe and extending along the longitudinal direction, and a fourth preionization outer electrode extending along the longitudinal direction, including a fourth end portion facing an outer circumference surface of the fourth dielectric pipe, and extending from the fourth end portion in a direction away from the fourth dielectric pipe,
in the plane perpendicular to the longitudinal direction, a third corona discharge angle, facing a space between the first main electrode and the second main electrode among angles formed by a third tangent in contact with the third dielectric pipe at a third predetermined position of the third dielectric pipe closest to the third end portion and a straight line that passes through the third predetermined position and extends in a direction in which the third preionization outer electrode extends from the third end portion, is an acute angle, and
in the plane perpendicular to the longitudinal direction, a fourth corona discharge angle, facing a space between the first main electrode and the second main electrode among angles formed by a fourth tangent in contact with the fourth dielectric pipe at a fourth predetermined position of the fourth dielectric pipe closest to the fourth end portion and a straight line that passes through the fourth predetermined position and extends in a direction in which the fourth preionization outer electrode extends from the fourth end portion, is an acute angle.

10. The chamber for a gas laser device according to claim 9,
wherein the first preionization inner electrode is electrically connected to the second preionization inner electrode,
the third preionization inner electrode is electrically connected to the fourth preionization inner electrode,
the first preionization outer electrode and the third preionization outer electrode are electrically connected to the first main electrode, and
the second preionization outer electrode and the fourth preionization outer electrode are electrically connected to the second main electrode.

11. A gas laser device including a chamber that encloses a laser gas at an internal space thereof,
the chamber comprising:
a first main electrode and a second main electrode arranged with a longitudinal direction thereof being along a predetermined direction as being spaced apart from and facing each other in the internal space;
a window arranged at a wall surface of the chamber and configured to transmit light from the internal space; and
a first preionization electrode arranged beside one side of the first main electrode,
the first preionization electrode including a first dielectric pipe extending along the longitudinal direction, a first preionization inner electrode arranged in the first dielectric pipe and extending along the longitudinal direction, and a first preionization outer electrode extending along the longitudinal direction, including a first end portion facing an outer circumference surface of the first dielectric pipe, and extending from the first end portion in a direction away from the first dielectric pipe, and
in a plane perpendicular to the longitudinal direction, a first corona discharge angle, as facing a space between the first main electrode and the second main electrode among angles formed by a first tangent in contact with the first dielectric pipe at a first predetermined position of the first dielectric pipe closest to the first end portion and a straight line that passes through the first predetermined position and extends in a direction in which the first preionization outer electrode extends from the first end portion, being an acute angle.

12. The gas laser device according to claim 11,
wherein a gas pressure in the chamber is equal to or higher than 200 kPa and equal to or lower than 420 kPa.

13. An electronic device manufacturing method, comprising:
generating laser light using a gas laser device;
outputting the laser light to an exposure apparatus; and
exposing a photosensitive substrate to the laser light in the exposure apparatus to manufacture an electronic device,
the gas laser device including a chamber for the gas laser device having an internal space in which a laser gas is enclosed,
the chamber including:
a first main electrode and a second main electrode arranged with a longitudinal direction thereof being along a predetermined direction as being spaced apart from and facing each other in the internal space;
a window arranged at a wall surface of the chamber and configured to transmit light from the internal space; and
a first preionization electrode arranged beside one side of the first main electrode,
the first preionization electrode including a first dielectric pipe extending along the longitudinal direction, a first preionization inner electrode arranged in the first dielectric pipe and extending along the longitudinal direction, and a first preionization outer electrode extending along the longitudinal direction, including a first end portion facing an outer circumference surface of the first dielectric pipe, and extending from the first end portion in a direction away from the first dielectric pipe, and
in a plane perpendicular to the longitudinal direction, a first corona discharge angle, as facing a space between the first main electrode and the second main electrode among angles formed by a first tangent in contact with the first dielectric pipe at a first predetermined position of the first dielectric pipe closest to the first end portion and a straight line that passes through the first predetermined position and extends in a direction in which the first preionization outer electrode extends from the first end portion, being an acute angle.
